(19) United States
(12) Patent Application Publication
(10) Pub. No.: US 2012/0181132 A1
(43) Pub. Date: Jul. 19, 2012

(54) Pawl carrier for wheel hub of bicycle

(75) Inventor: Ming Huang Kuo, Changhua (TW)

(73) Assignee: Taiwan Jiali Transmission Co., Ltd.

(21) Appl. No.: 12/930,875

(22) Filed: Jan. 19, 2011

(51) Int. Cl. F16D 41/30

(52) U.S. Cl. 192/45.1

(57) ABSTRACT

A pawl carrier includes a tubular part having a number of depressions equally spaced from each other, and a number of openings located beside the depressions, the tubular part includes one or more latches for forming the opening of the tubular part, a number of ratchet pawls are engaged in the depressions of the tubular part and each has a tongue, and a number of spring biasing devices each include an anchoring member for engaging into the opening of the tubular part and each include an extension for engaging with the ratchet pawl and for anchoring the ratchet pawl to the tubular part, the latches of the tubular part are engaged with the anchoring member for retaining the anchoring member to the tubular part.

### BACKGROUND OF THE INVENTION

1. Field of the Invention

The present invention relates to a pawl carrier for a wheel hub for a wheeled vehicle, such as a bicycle, and more particularly to a pawl carrier for a wheel hub including an improved spring biasing device for solidly and stably attaching or mounting or securing to the wheel hub and having an outwardly extended leg or limb for suitably engaging with the ratchet pawls and for solidly and stably anchoring or securing or retaining the ratchet pawls to the wheel hub.

2. Description of the Prior Art

Typical wheeled vehicles, such as motorcycles, bicycles, or the other wheeled vehicles comprise an inner tubular part, collar, slider, or pawl carrier pivotally or rotatably received or engaged in an outer body, ring, sleeve, output element, driver member or hub shell or the like, and a number of spring-biased ratchet pawls disposed or engaged between the inner pawl carrier and the outer hub shell for forming a unidirectional mechanism in order to control or to limit the rotational movement between the inner pawl carrier and the outer hub shell.

For example, U.S. Pat. No. 3,182,529 to Schwerdhofer, U.S. Pat. No. 4,301,903 to Nakano, U.S. Pat. No. 4,840,260 to Josereau, and U.S. Pat. No. 5,024,121 to Hsieh disclose several of the typical wheel hubs of the wheeled vehicles or bicycles each comprising two or more ratchet pawls disposed or attached or mounted to an inner tubular part, collar, slider, or pawl carrier for selectively engaging with the outer body, ring, sleeve, output element, driver member or hub shell, and a circular retaining or clamping ring engaged onto the inner tubular part, collar, slider, or pawl carrier for engaging with the ratchet pawls and for anchoring or securing or retaining the ratchet pawls between the inner pawl carrier and the outer hub shell.

However, the single circular retaining or clamping ring may not be used to suitably engage with the ratchet pawls and to apply a uniform spring biasing force to the ratchet pawls respectively such that the ratchet pawls may not be used and biased to suitably or effectively engage with the outer hub shell and may not be solidly and stably anchored or secured or retained to the inner collar or pawl carrier.

U.S. Pat. No. 4,058,192 to Haigh, U.S. Pat. No. 4,324,323 to Campagnolo, and U.S. Pat. No. 4,702,486 to Tsuchie disclose several further typical wheel hubs of the wheeled vehicles or bicycles each also comprising two or more ratchet pawls disposed or attached or mounted to an inner tubular part or collar or pawl carrier for selectively engaging with the outer body or sleeve or hub shell, and a number of spring biasing members disposed or attached or mounted to the inner pawl carrier for selectively engaging with the ratchet pawls and for biasing the ratchet pawls to suitably engage with the outer hub shell.

However, the strength of the inner pawl carrier will be decreased due to the attachment or the engagement of the spring biasing members within the inner pawl carrier, or alternatively, the spring biasing members may include a rather complicated structure that may not be easily and quickly manufactured and that may not be easily assembled between the inner pawl carrier and the outer hub shell.

The present invention has arisen to mitigate and/or obviate the afore-described disadvantages of the conventional pawl carriers for the wheel hubs of the bicycles.

### SUMMARY OF THE INVENTION

The primary objective of the present invention is to provide a pawl carrier for a wheel hub including an improved spring biasing device for solidly and stably attaching or mounting or securing to the wheel hub and having an outwardly extended leg or limb for suitably engaging with the ratchet pawls and for solidly and stably anchoring or securing or retaining the ratchet pawls to the wheel hub.

The other objective of the present invention is to provide a pawl carrier for a wheel hub including an improved spring biasing device for easily and quickly attaching or mounting or securing to the wheel hub without additional tools.

In accordance with one aspect of the invention, there is provided a pawl carrier for a wheel hub comprising a tubular part including a bore formed therein for engaging with a spindle, and including a number of first depressions formed in an outer peripheral portion of the tubular part and equally spaced from each other, and including a number of openings formed in the outer peripheral portion of the tubular part and located beside the first depressions of the tubular part respectively, the tubular part including at least one latch extended into each the opening of the tubular part for defining the opening of the tubular part, a number of ratchet pawls each including a base portion pivotally received and engaged in the first depression of the tubular part respectively, and each including a tongue extended out of the first depression of the tubular part, and a number of spring biasing devices each including an anchoring member for engaging into the opening of the tubular part respectively, and each including an extension extended outwardly therefrom for engaging with the ratchet pawl and for anchoring and retaining the ratchet pawl to the tubular part without additional tools, and for biasing and forcing the tongue of the ratchet pawl out of the first depression of the tubular part to engage with the hub shell of the wheel hub, the latch of the tubular part is engaged with the anchoring member for anchoring and retaining or securing the anchoring member of the spring biasing device to the tubular part.

The anchoring member of the spring biasing device includes at least one leg extended outwardly therefrom for engaging with the latch of the tubular part and for anchoring the spring biasing device to the tubular part.

The opening of the tubular part includes a C or U-shaped structure or configuration formed or defined by the latch of the tubular part for receiving or engaging with the anchoring member of the spring biasing device. The spring biasing devices each include a catch provided on the extension for stably engaging with the ratchet pawl.

The ratchet pawls each include a slot formed therein for receiving and engaging with the extension of the spring biasing device. The tubular part includes a channel formed therein and communicative with the first depressions and the openings of the tubular part for receiving and engaging with the extension of the spring biasing device.

The tubular part includes a number of second depressions formed therein and located beside the openings of the tubular part respectively and each for engaging with a second ratchet pawl, and the opening is located between the first depression and the second depression of the tubular part respectively, the spring biasing devices each include a second extension extended outwardly therefrom for engaging with the second ratchet pawl and for anchoring and retaining the second ratchet pawl to the tubular part. The spring biasing devices each include a catch provided on the second extension for engaging with the second ratchet pawl and for solidly and stably anchoring or securing or retaining the second ratchet pawls to the tubular part and for preventing the second ratchet pawls from being disengaged from the tubular part inadvertently.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a pawl carrier for a wheel hub of a wheeled vehicle in accordance with the present invention;

FIG. 2 is a perspective view of the pawl carrier for the wheel hub of the wheeled vehicle;

FIG. 3 is a top plan schematic view of the pawl carrier for the wheel hub of the wheeled vehicle;

FIG. 4 is an enlarged partial cross sectional view of the pawl carrier for the wheel hub of the wheeled vehicle, taken along lines 4-4 of FIG. 2;

FIG. 5 is another enlarged partial cross sectional view similar to FIG. 4, illustrating the operation of the pawl carrier for the wheel hub; and

FIG. 6 is a further partial exploded view illustrating the other arrangement of the pawl carrier for the wheel hub of the wheeled vehicle or bicycle.

### DETAILED DESCRIPTION OF THE PREFERRED EMBODIMENT

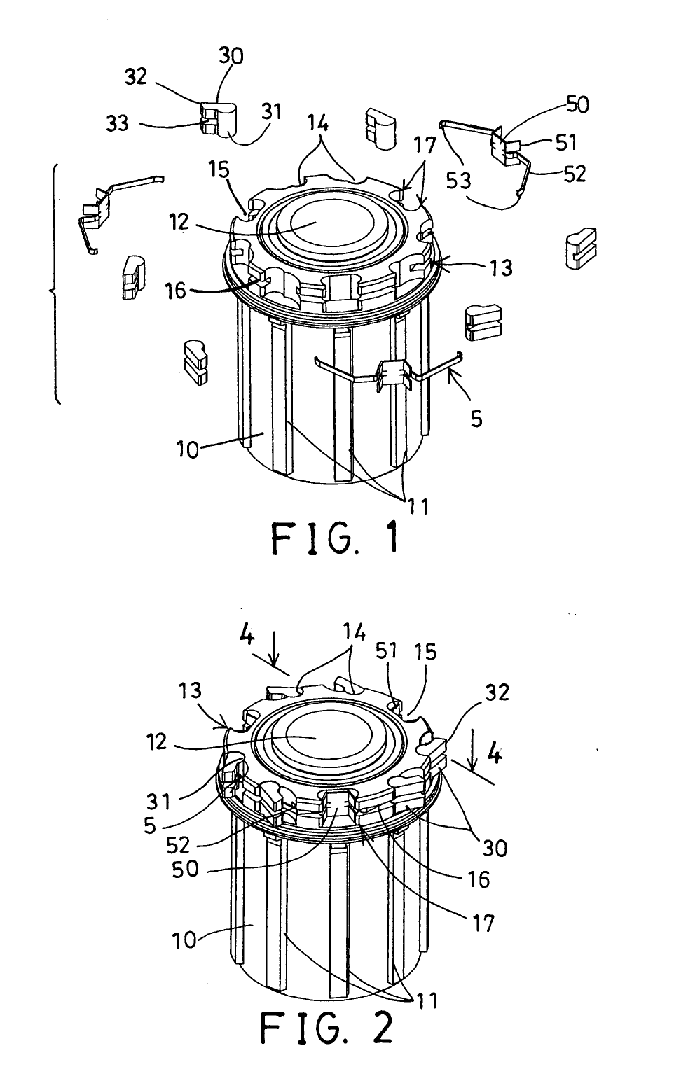

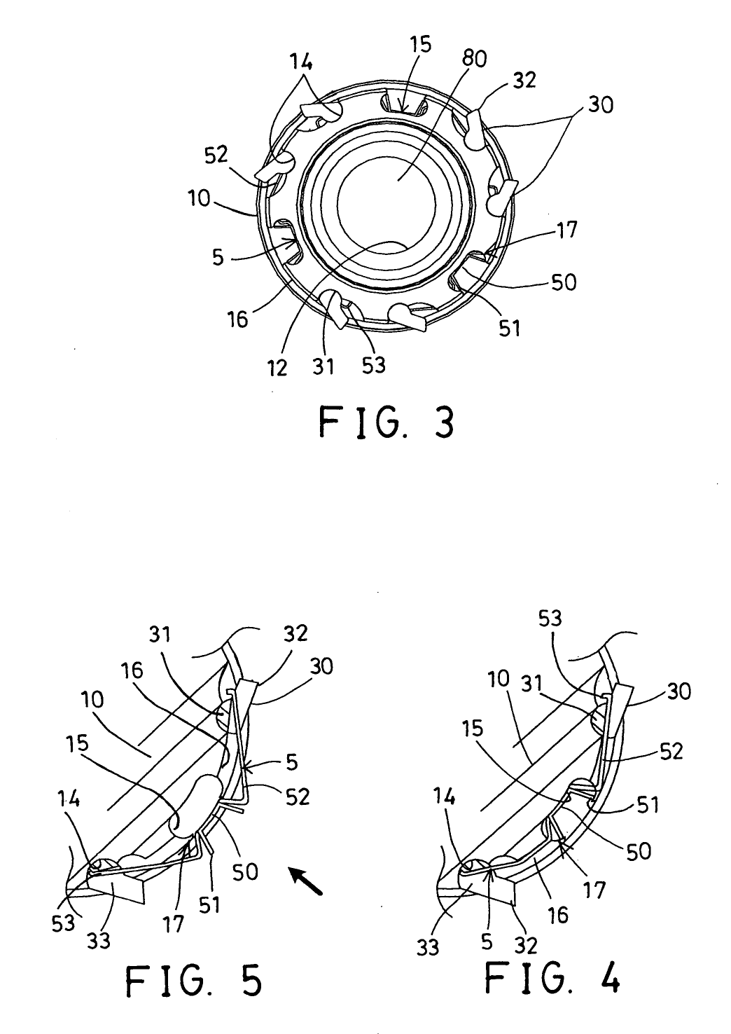

Referring to the drawings, and initially to FIGS. 1-4, a pawl carrier for a wheel hub (not shown) in accordance with the present invention comprises a carrier or hub body, an inner slider, collar, or tubular part 10 including a number of longitudinal keys or ribs 11 extended outwardly therefrom, and including a chamber or bore 12 formed therein for pivotally or rotatably receiving or engaging with a shaft or spindle 80 (FIG. 3) of the wheel hub of a bicycle (not shown) or the like, and the wheel hub may include an outer body, ring, sleeve, output element, driver member or hub shell (not shown) or the like pivotally or rotatably attached or mounted or engaged onto the outer peripheral portion of the tubular part 10 for attaching or mounting or carrying or supporting one or more sprockets thereon (not shown). The outer body or hub shell and the sprockets are not related to the present invention and will not be described in further details.

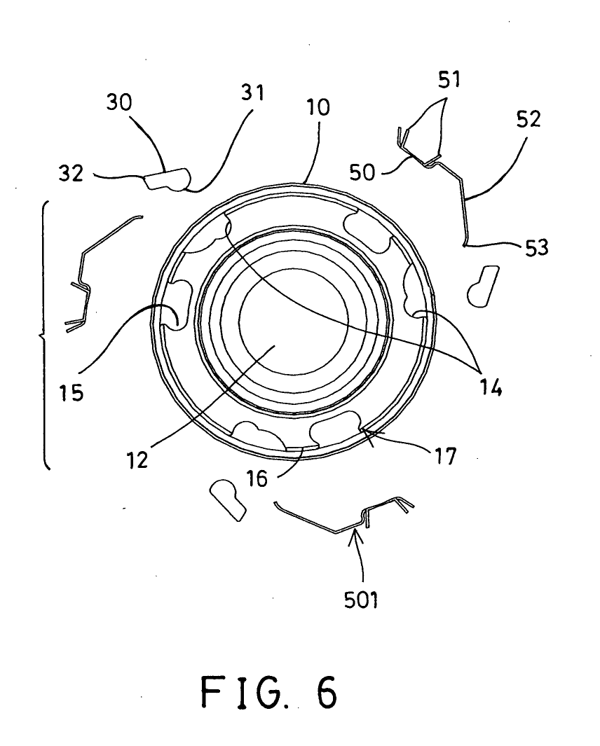

The tubular part 10 includes an upper portion or one end portion 13 having a number of curved cavities or depressions 14 formed therein, such as formed in the outer peripheral portion thereof and preferably and equally spaced from each other and each for pivotally receiving or engaging with a base portion 31 of a spring-biased ratchet pawl 30, and includes a number of recesses or openings 15 also formed in the outer peripheral portion of the one end portion 13 thereof and also preferably and equally spaced from each other and disposed or located beside the depressions 14 thereof respectively (FIG. 6), or the openings 15 of the tubular part 10 are disposed or located between the depressions 14 thereof respectively (FIGS. 1-5) and each for receiving or engaging with a spring biasing device 5.

As shown in FIGS. 1 and 2, the tubular part 10 further includes an annular or peripheral groove or channel 16 also formed in the outer peripheral portion of the one end portion 13 and communicative with the depressions 14 and the openings 15 of the tubular part 10 for receiving or engaging with the spring biasing device 5. As best shown in FIGS. 3-5, the openings 15 of the tubular part 10 include a C or U-shaped structure or configuration formed or defined by one or more (such as two) protrusions or latches 17 that are partially extended into the openings 15 of the tubular part 10 for engaging with the spring biasing device 5 and for anchoring or securing or retaining the spring biasing device 5 to the tubular part 10, which will be discussed hereinafter.

The ratchet pawls 30 each include an end portion or tongue 32 extended out of the depressions 14 of the tubular part 10 for engaging with the outer body or hub shell of the wheel hub of the bicycle and for forming a unidirectional mechanism in order to control or to limit the rotational movement between the inner tubular part 10 and the outer hub shell, and each include a passage or slot 33 formed in the outer portion thereof and aligned with or communicative with the channel 16 of the tubular part 10 for engaging with the spring biasing device 5. For example, the spring biasing devices 5 each include a C or U or (-shaped structure or configuration or body or casing or bracket or anchoring member 50 for engaging into the openings 15 of the tubular part 10 respectively (FIGS. 4 and 5) and having one or more limbs or legs 51 for engaging with the latches 17 of the tubular part 10 and for solidly and stably anchoring or securing or retaining the spring biasing device 5 to the tubular part 10.

The spring biasing devices 5 each further include two legs or extensions 52 extended outwardly therefrom, such as extended outwardly from the legs 51, or cut from the legs 51 respectively for forming or defining a substantially 3-shaped structure or configuration and for engaging into the channel 16 of the tubular part 10 and also for engaging through the slot 33 of the ratchet pawl 30 respectively and also for engaging with the ratchet pawl 30 (FIGS. 4, 5) and thus for solidly and stably anchoring or securing or retaining the ratchet pawls 30 to the tubular part 10, and for biasing or forcing the tongues 32 of the ratchet pawls 30 out of the depressions 14 of the tubular part 10, and for biasing or forcing the tongues 32 of the ratchet pawls 30 to engage with the outer body or hub shell of the wheel hub of the bicycle. It is preferable that the spring biasing devices 5 each include a folded end portion or catch 53 formed or provided on the free end portion of each of the extensions 52 thereof for engaging with the ratchet pawl 30 and for further solidly and stably anchoring or securing or retaining the ratchet pawls 30 to the tubular part 10 and for preventing the ratchet pawls 30 from being disengaged from the tubular part 10 inadvertently.

In operation, as shown in FIGS. 3-5, the anchoring members 50 of the spring biasing devices 5 may be easily and quickly engaged into the openings 15 of the tubular part 10 respectively without additional tools, and the extensions 52 of the spring biasing devices 5 may be easily and quickly engaged into or through the channel 16 of the tubular part 10 and the slot 33 of the ratchet pawl 30 respectively for engaging with the ratchet pawl 30 and for solidly and stably anchoring or securing or retaining the ratchet pawls 30 to the tubular part 10, and for biasing or forcing the tongues 32 of the ratchet pawls 30 to engage with the outer body or hub shell of the wheel hub of the bicycle.

It is to be noted that the spring biasing device 5 may be solidly and stably anchored or secured or retained to the tubular part 10 by engaging the anchoring members 50 into the openings 15 of the tubular part 10 respectively, and the ratchet pawls 30 may then be solidly and stably anchored or secured or retained to the tubular part 10 with the extensions 52 of the spring biasing devices 5; i.e., the extensions 52 of the spring biasing devices 5 may solidly and stably engage with the ratchet pawls 30 and may apply a uniform spring biasing force to the ratchet pawls 30 respectively and may suitably or effectively bias and force the tongues 32 of the ratchet pawls 30 to engage with the outer body or hub shell of the wheel hub of the bicycle.

Alternatively, as shown in FIG. 6, the spring biasing device 501 may include a single extension 52 extended outwardly therefrom, instead of the two extensions 52 that are extended outwardly from the spring biasing device 5 as that shown in FIGS. 1-5, for engaging with the selected or single ratchet pawl 30 and thus for solidly and stably anchoring or securing or retaining the selected or single ratchet pawl 30 to the tubular part 10, and for preventing the ratchet pawls 30 from being disengaged from the tubular part 10 inadvertently, and for biasing or forcing the tongue 32 of the ratchet pawl 30 to suitably or effectively engage with the outer body or hub shell of the wheel hub of the bicycle.

Accordingly, the pawl carrier for the wheel hub in accordance with the present invention includes an improved spring biasing device for solidly and stably attaching or mounting or securing to the wheel hub and having an outwardly extended leg or limb for suitably engaging with the ratchet pawls and for solidly and stably anchoring or securing or retaining the ratchet pawls to the wheel hub.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pawl carrier for a wheel hub comprising:
a tubular part including a bore formed therein for engaging with a spindle, and including a plurality of first depressions formed in an outer peripheral portion of said tubular part and equally spaced from each other, and including a plurality of openings formed in the outer peripheral portion of said tubular part and located beside said first depressions of said tubular part respectively, said tubular part including at least one latch extended into each said opening of said tubular part for defining said opening of said tubular part,
a plurality of ratchet pawls each including a base portion pivotally received and engaged in said first depression of said tubular part respectively, and each including a tongue extended out of said first depression of said tubular part, and
a plurality of spring biasing devices each including an anchoring member for engaging into said opening of said tubular part respectively, and each including an extension extended outwardly therefrom for engaging with said ratchet pawl and for anchoring and retaining said ratchet pawl to said tubular part, and for biasing and forcing said tongue of said ratchet pawl out of said first depression of said tubular part, said at least one latch of said tubular part being engaged with said anchoring member for anchoring and retaining said anchoring member of said spring biasing device to said tubular part.

2. The pawl carrier as claimed in claim 1, wherein said anchoring member of said spring biasing device includes at least one leg for engaging with said at least one latch of said tubular part and for anchoring said spring biasing device to said tubular part.

3. The pawl carrier as claimed in claim 1, wherein said opening of said tubular part includes a U-shaped structure defined by said at least one latch of said tubular part for receiving said anchoring member of said spring biasing device.

4. The pawl carrier as claimed in claim 1, wherein said spring biasing devices each include a catch provided on said extension for engaging with said ratchet pawl.

5. The pawl carrier as claimed in claim 1, wherein said ratchet pawls each include a slot formed therein for receiving and engaging with said extension of said spring biasing device.

6. The pawl carrier as claimed in claim 5, wherein said tubular part includes a channel formed therein and communicative with said first depressions and said openings of said tubular part for receiving and engaging with said extension of said spring biasing device.

7. The pawl carrier as claimed in claim 1, wherein said tubular part includes a plurality of second depressions formed therein and located beside said openings of said tubular part respectively and each for engaging with a second ratchet pawl, and said opening is located between said first depression and said second depression of said tubular part respectively, said spring biasing devices each include a second extension extended outwardly therefrom for engaging with said second ratchet pawl and for anchoring and retaining said second ratchet pawl to said tubular part.

8. The pawl carrier as claimed in claim 7, wherein said spring biasing devices each include a catch provided on said second extension for engaging with said second ratchet pawl.
